(19) United States
(12) Patent Application Publication
(10) Pub. No.: US 2022/0327428 A1
(43) Pub. Date: Oct. 13, 2022

(54) Executing Machine-Learning Models

(71) Applicant: Telefonaktiebolaget LM Ericsson (publ), Stockholm (SE)

(72) Inventors: Bin Sun, Luleå (SE); Rafia Inam, Västerås (SE); Aneta Vulgarakis Feljan, Stockholm (SE); Konstantinos Vandikas, Solna (SE)

(21) Appl. No.: 17/616,369

(22) PCT Filed: Jun. 4, 2019
(86) PCT No.: PCT/SE2019/050512

§ 371 Date: Dec. 3, 2021

(51) Int. Cl. G06N 20/20; G06K 9/62; H04L 67/10

(52) U.S. Cl. CPC G06N 20/20; G06K 9/6296; H04L 67/10

(57) ABSTRACT

Embodiments described herein provided methods and apparatus for executing a machine-learning model. A first machine-learning model, based on a first set of data and using a machine-learning algorithm, is developed at a first node. A second machine-learning model, based on the first machine-learning model and a second set of data, and using the machine-learning algorithm, is developed at a second node. Information about a difference between the first machine-learning algorithm, at a second node machine-learning model and the second machine-learning model is communicated from the second node to the first node. A request for execution of a machine-learning model is received at the first node. Responsive to receiving the request for the execution of the machine-learning model, information indicative of an execution policy is obtained at the first node. Finally, depending on the obtained information indicative of an execution policy, either, at the first node, a machine-learning model based on the first machine-learning model and the information about a difference between the first machine-learning model and the second machine-learning model is executed to obtain a result; or the first machine-learning model is partially executed at the first node, and the second machine-learning model is partially executed at the second node, to obtain a result.

### FIELD OF THE INVENTION

Embodiments described herein relate to methods and apparatus for executing a machine-learning model.

### BACKGROUND

FIG. 1 shows an example of a network 100. The network 100 comprises a central node 102, and a plurality of edge nodes 104a, 104b, 104c. In this example, the edge nodes 104a, 104b, 104c, are communicatively interconnected to the central node 102 by the links 106a, 106b, 106c, respectively. The edge nodes 104a, 104b, 104c may be examples of edge-based deployments, and the central node 102 may be an example of a centralised deployment. It will be appreciated that, in the context of this disclosure, an edge-based deployment refers to an environment in which a machine-learning model may be executed or trained, where that environment is closer to a data source than a centralised environment, such as a data centre (for example, the central node 102). For example, an edge-based deployment may comprise user equipment.

As described above, the central node 102 may comprise one or more centralised sets of data. These one or more centralised sets of data may be used to train machine-learning models. Typically, a large, centralised set of data is required to train an accurate machine-learning model.

However, this need for a centralised set of data to train a machine learning model may be supplemented by employing distributed machine learning techniques (for example, federated learning). By employing a distributed machine learning technique, a trained machine-learning model may continue to be trained in an edge node 104a, 104b, 104c, within the network 100. This further training of the machine-learning model may be performed using a set of data that is comprised within the edge node 104a, 104b, 104c. In some embodiments, the set of data comprised within the edge node 104a, 104b, 104c, will have been locally generated at the edge node 104a, 104b, 104c.

Thus, distributed machine learning techniques allow updated machine-learning models to be trained at an edge node 104a, 104b, 104c, where these updated machine-learning models have been trained using data that has not been communicated to, and is not known to, the central node 102 (where the machine-learning model was initially trained). In other words, an updated machine-learning model may be trained locally at an edge node 104a, 104b, 104c, using a set of data that is only accessible locally at the edge node 104a, 104b, 104c, and may not be accessible at other nodes within the network 100. It may be that the local set of data comprises sensitive or otherwise private information that is not to be communicated to other nodes within the network 100.

One advantage of distributed learning techniques is that the need to communicate large volumes of data from an edge node 104a, 104b, 104c, to the central node 102 is reduced (for example, over the links 106a, 106b, 106c, respectively), as a centralised set of data may not need to be provided at the central node 102. Another further advantage is that the amount of data storage required at the central node 102 may be reduced.

Furthermore, it is advantageous that, if the edge node 104a, 104b, 104c, communicates an updated machine-learning model to the central node 102, it is only necessary to communicate the update (in other words, the change) to the machine-learning model, and it is not necessary that the entire updated machine-learning model is communicated. Thus, an updated machine-learning model may be trained and communicated more securely in a network 100.

Additionally, as only the update to the machine-learning model is communicated, little or no information relating to the set of data that was used to train the updated machine-learning model is communicated to the central node 102. This preserves the privacy of the set of data that was used to train the updated machine learning model, as no information relating to the data (which may have been generated at the central node 102) is communicated to the central node 102.

However, this technique is only able to preserve privacy of the updated machine-learning model, and of the set of data stored at the edge node 104a, 104b, 104c, if the machine-learning model comprises a neural network.

For example, when the machine-learning model comprises a decision tree (which, similarly to a neural network, employs a computational graph), if an update to the machine-learning model comprises a change to a decision node comprised within the decision tree, this update may provide information to the central node 102 relating to the set of data that was used to train the updated decision tree. For example, it may be possible to infer information relating to the set of data used to train the updated model at the central node 102, where that set of data was intended to remain private to the edge node 104a, 104b, 104c. This may be unacceptable in situations where the privacy requirements of data that is generated and/or stored at an edge node 104a, 104b, 104c, are very high. For example, the central node 102 may represent a service provider, and the edge nodes 104a, 104b, 104c, may represent customers of the service provider. In this example, the data (and information that may be inferred from this data) that is generated and/or stored at the customer environments may be required to remain locally within the customer environments. This may be a requirement, for example, in certain medical environments, in certain telecommunications environments (where the geofencing of data generated and/or stored in particular nodes and/or deployments may be employed), and may also be required to conform to data protection rules, such as the European Union General Data Protection Regulation (GDPR).

Thus, it would be advantageous to be able to communicate the updates of updated machine-learning models that have been trained at an edge node 104a, 104b, 104c, in a manner that does not reveal information relating to the data set that was used to train the updated machine-learning model.

### SUMMARY

According to a first aspect, there is provided a method for executing a machine-learning model, the method comprising:

developing a first machine-learning model, based on a first set of data and using a machine-learning algorithm, at a first node;

developing a second machine-learning model, based on the first machine-learning model and a second set of data, and using the machine-learning algorithm, at a second node;

communicating, from the second node to the first node, information about a difference between the first machine-learning model and the second machine-learning model;

receiving, at the first node, a request for execution of a machine-learning model;

responsive to receiving the request for the execution of the machine-learning model, at the first node, obtaining information indicative of an execution policy; and

depending on the obtained information indicative of an execution policy, either: executing, at the first node, a machine-learning model based on the first machine-learning model and the information about a difference between the first machine-learning model and the second machine-learning model, to obtain a result; or

partially executing the first machine-learning model at the first node, and partially executing the second machine-learning model at the second node, to obtain a result.

According to another aspect, there is provided a system for executing a machine-learning model, the system comprising:

a first network node; and

a second network node, wherein the system is configured to perform a method according to the first aspect.

According to a further aspect, there is provided a computer program product, comprising computer readable code, configured for causing a suitable programmed processor to perform a method according to the first aspect.

According to a still further aspect, there is provided a computer program product, comprising a tangible computer readable medium, containing computer readable instructions for causing a processor to perform a method comprising:

developing a first machine-learning model, based on a first set of data and using a machine-learning algorithm, at a first node;

developing a second machine-learning model, based on the first machine-learning model and a second set of data, and using the machine-learning algorithm, at a second node;

communicating, from the second node to the first node, information about a difference between the first machine-learning model and the second machine-learning model;

receiving, at the first node, a request for execution of a machine-learning model;

responsive to receiving the request for the execution of the machine-learning model, at the first node, obtaining information indicative of an execution policy; and

depending on the obtained information indicative of an execution policy, either:

executing, at the first node, a machine-learning model based on the first machine-learning model and the information about a difference between the first machine-learning model and the second machine-learning model, to obtain a result; or

partially executing the first machine-learning model at the first node, and partially executing the second machine-learning model at the second node, to obtain a result.

According to a second aspect, there is provided a method for executing a machine-learning model performed in a first node, the method comprising:

developing a first machine-learning model, based on a first set of data and using a machine-learning algorithm, at a first node;

communicating to a second network node, the first machine-learning model;

receiving from the second node, information about a difference between the first machine-learning model and a second machine-learning model;

receiving, a request for the execution of a machine-learning model;

responsive to receiving the request for the execution of the machine-learning model, obtaining information indicative of an execution policy; and

depending on the obtained information indicative of an execution policy, either:

executing a machine-learning model based on the first machine-learning model and the information about a difference between the first machine-learning model and the second machine-learning model, to obtain a result; or

partially executing the first machine-learning model, and causing the second node to partially execute the second machine-learning model, to obtain a result.

According to another aspect, there is provided a first network node for executing a machine-learning model, the first network node comprising:

an interface configured for allowing communication with other network nodes;

a memory; and

a processor,

wherein the first network node is configured to perform a method according to the second aspect.

According to a further aspect, there is provided a computer program product, comprising computer readable code, configured for causing a suitable programmed processor to perform a method according to the second aspect.

According to a still further aspect, there is provided a computer program product, comprising a tangible computer readable medium, containing computer readable instructions for causing a processor to perform a method comprising:

developing a first machine-learning model, based on a first set of data and using a machine-learning algorithm, at a first node;

communicating to a second network node, the first machine-learning model;

receiving from the second node, information about a difference between the first machine-learning model and a second machine-learning model;

receiving, a request for the execution of a machine-learning model;

responsive to receiving the request for the execution of the machine-learning model, obtaining information indicative of an execution policy; and

depending on the obtained information indicative of an execution policy, either:

executing a machine-learning model based on the first machine-learning model and the information about a difference between the first machine-learning model and the second machine-learning model, to obtain a result; or

partially executing the first machine-learning model, and causing the second node to partially execute the second machine-learning model, to obtain a result.

According to a third aspect, there is provided a method for executing a machine-learning model performed in a second node, the method comprising:

receiving, from a first node, a first machine-learning model;

developing a second machine-learning model, based on the first machine-learning model and a second set of data, and using the machine-learning algorithm;

communicating, to the first node, information about a difference between the first machine-learning model and the second machine-learning model;

receiving, from the first node, a partial result;

partially executing the second machine-learning model, using the first partial result, to form a second partial result; and

communicating, to the first node, the second partial result.

According to another aspect, there is provided a second network node for executing a machine-learning model, the second network node comprising:

an interface configured for allowing communication with other network nodes;

a memory; and

a processor,

wherein the second network node is configured to perform a method according to the third aspect.

According to a further aspect, there is provided a computer program product, comprising computer readable code, configured for causing a suitable programmed processor to perform a method according to the third aspect.

According to a still further aspect, there is provided a computer program product, comprising a tangible computer readable medium, containing computer readable instructions for causing a processor to perform a method comprising:

receiving, from a first node, a first machine-learning model;

developing a second machine-learning model, based on the first machine-learning model and a second set of data, and using the machine-learning algorithm;

communicating, to the first node, information about a difference between the first machine-learning model and the second machine-learning model;

receiving, from the first node, a partial result;

partially executing the second machine-learning model, using the first partial result, to form a second partial result; and

communicating, to the first node, the second partial result.

According to a fourth aspect, there is provided a method for developing a machine-learning model, the method comprising:

developing a first machine-learning model, based on a first set of data and using a machine-learning algorithm, at a first node;

developing a second machine-learning model, based on the first machine-learning model and a second set of data, and using the machine-learning algorithm, at a second node;

communicating, from the second node to the first node, information about a difference between the first machine-learning model and the second machine-learning model.

The information about a difference between the first machine-learning model and the second machine-learning model may comprise information that the second machine-learning model is different from the first machine-learning model.

The information about a difference between the first machine-learning model and the second machine-learning model may comprise information that the second machine-learning model is different from the first machine-learning model, or may comprise information that the second machine-learning model is not different to the first machine-learning model.

The information about a difference between the first machine-learning model and the second machine-learning model may further comprise information identifying a difference between the first machine-learning model and the second machine-learning model.

The information about a difference between the first machine-learning model and the second machine-learning model may further comprise the second machine-learning model.

The first machine-learning model and the second machine-learning model may each be able to be represented by a computational graph. The computational graphs may then be directed acyclic graphs.

The first machine-learning model and the second machine-learning model may each be one of the following: neural networks, support vector machines, decision trees, and random forests.

According to another aspect, there is provided a system for developing a machine-learning model, the system comprising:

a first network node; and

a second network node,

wherein the system is configured to perform a method according to the fourth aspect.

According to a further aspect, there is provided a computer program product, comprising computer readable code, configured for causing a suitable programmed processor to perform a method according to the fourth aspect.

According to a still further aspect, there is provided a computer program product, comprising a tangible computer readable medium, containing computer readable instructions for causing a processor to perform a method comprising:

developing a first machine-learning model, based on a first set of data and using a machine-learning algorithm, at a first node;

developing a second machine-learning model, based on the first machine-learning model and a second set of data, and using the machine-learning algorithm, at a second node;

communicating, from the second node to the first node, information about a difference between the first machine-learning model and the second machine-learning model.

According to a fifth aspect, there is provided a method for executing a machine-learning model, the method comprising:

receiving, at a first node, a request for execution of a machine-learning model;

responsive to receiving the request for the execution of the machine-learning model, at the first node, obtaining information indicative of an execution policy; and

depending on the obtained information indicative of an execution policy, either: executing, at the first node, a machine-learning model based on a first machine-learning model and information about a difference between the first machine-learning model and a second machine-learning model, to obtain a result; or

partially executing the first machine-learning model at the first node, and partially executing the second machine-learning model at a second node, to obtain a result.

The method may further comprise communicating the obtained result.

The step of partially executing the first machine-learning model at the first node, and partially executing the second machine-learning model at a second node, to obtain a result may comprise:

partially executing the first machine-learning model at the first node; and

at the first node, causing the second machine-learning model to be partially executed at the second node based on the information about a difference between the first machine-learning model and the second machine-learning model.

The information about a difference between the first machine-learning model and the second machine-learning model may comprise information that the second machine-learning model is different from the first machine-learning model.

The information about a difference between the first machine-learning model and the second machine-learning model may comprise information that the second machine-learning model is different from the first machine-learning model, or may comprise information that the second machine-learning model is not different to the first machine-learning model.

The information about a difference between the first machine-learning model and the second machine-learning model may further comprise information identifying a difference between the first machine-learning model and the second machine-learning model.

The information about a difference between the first machine-learning model and the second machine-learning model may further comprise the second machine-learning model.

The information indicative of an execution policy may be obtained from a policy node.

The information indicative of an execution policy may be obtained from memory in the first node.

When the information indicative of the execution policy comprises information indicating execution, at the first node, of the machine-learning model based on the first machine-learning model and the information about a difference between the first machine-learning model and the second machine-learning model, said information may further comprise information indicating that at least part of said machine-learning model should be executed in an enclaved mode.

When the information indicative of the execution policy comprises information indicating partial execution of the first machine-learning model at the first node and partial execution of the second machine-learning model at the second node, said information may further comprise information indicating that at least one component of said first machine-learning model or of said second machine-learning model should be executed in an enclaved mode.

The first machine-learning model and the second machine-learning model may each be able to be represented by a computational graph. The computational graphs may be directed acyclic graphs.

The first machine-learning model and the second machine-learning model may each be one of the following: neural networks, support vector machines, decision trees, and random forests.

The step of executing, at the first node, a machine-learning model based on the first machine-learning model and the information about a difference between the first machine-learning model and the second machine-learning model to obtain a result may comprise at least partially executing, at the first node, a machine-learning model based on the first machine-learning model and the information about a difference between the first machine-learning model and the second machine-learning model in an enclaved memory segment.

The step of partially executing the first machine-learning model at the first node, and partially executing the second machine-learning model at the second node to obtain a result may comprise executing at least one component of the first machine-learning model at the first node in an enclaved memory segment.

The step of partially executing the first machine-learning model at the first node, and partially executing the second machine-learning model at the second node to obtain a result may comprise executing at least one component of the second machine-learning model at the second node in an enclaved memory segment.

The step of partially executing the first machine-learning model at the first node, and partially executing the second machine-learning model at the second node to obtain a result may comprise:

partially executing the first machine-learning model at the first node, to form a first partial result;

communicating, from the first node to the second node, the first partial result;

partially executing the second machine-learning model, using the first partial result, at the second node, to form a second partial result;

communicating, from the second node to the first node, the second partial result;

partially executing the first machine-learning model, using the second partial result, at the first node, to form a final result.

According to another aspect, there is provided a system for executing a machine-learning model, the system comprising:

a first network node; and

a second network node,

wherein the system is configured to perform a method according to the fifth aspect.

According to a further aspect, there is provided a computer program product, comprising computer readable code, configured for causing a suitable programmed processor to perform a method according to the fifth aspect.

According to a still further aspect, there is provided a computer program product, comprising a tangible computer readable medium, containing computer readable instructions for causing a processor to perform a method comprising:

receiving, at a first node, a request for execution of a machine-learning model;

responsive to receiving the request for the execution of the machine-learning model, at the first node, obtaining information indicative of an execution policy; and

depending on the obtained information indicative of an execution policy, either:

executing, at the first node, a machine-learning model based on a first machine-learning model and information about a difference between the first machine-learning model and a second machine-learning model, to obtain a result; or

partially executing the first machine-learning model at the first node, and partially executing the second machine-learning model at a second node, to obtain a result.

### BRIEF DESCRIPTION OF DRAWINGS

For a better understanding of the present invention, and to show how it may be put into effect, reference will now be made, by way of example only, to the accompanying drawings, in which:

FIG. 1 illustrates an example of a network;

FIG. 2 illustrates a first node according to some embodiments comprising a processor (or logic);

FIG. 3 illustrates a second node according to some embodiments comprising a processor (or logic);

FIG. 4 illustrates an example of a decision tree;

FIG. 5 illustrates an example of a neural network;

FIG. 6 illustrates a sequence diagram for executing a machine-learning model; and

FIG. 7 illustrates a method for executing a machine-learning model according to some embodiments of the disclosure.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

The following sets forth specific details, such as particular embodiments for purposes of explanation and not limitation. But it will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

The description involves communication between network nodes, which may comprise multiple network nodes. However the network nodes may comprise radio access nodes for example eNodeBs (eNBs), as defined by 3GPP, or gNodeBs (gNBs) as utilised in the future standards expected to meet the 5G requirements. However, it will be appreciated that the concepts described herein may involve any network nodes. Moreover, where the following description refers to steps taken in or by a network node, this also includes the possibility that some or all of the processing and/or decision making steps may be performed in a device that is physically separate from the radio antenna of the radio access node, but is logically connected thereto. Thus, where processing and/or decision making is carried out “in the cloud”, the relevant processing device is considered to be part of the radio access node for these purposes.

Embodiments described herein provide methods and apparatus for executing a machine-learning model that is based upon the policies that exist between the different nodes where different parts of the machine-learning model have been updated, is provided. In particular, embodiments described herein mitigate the problems described above.

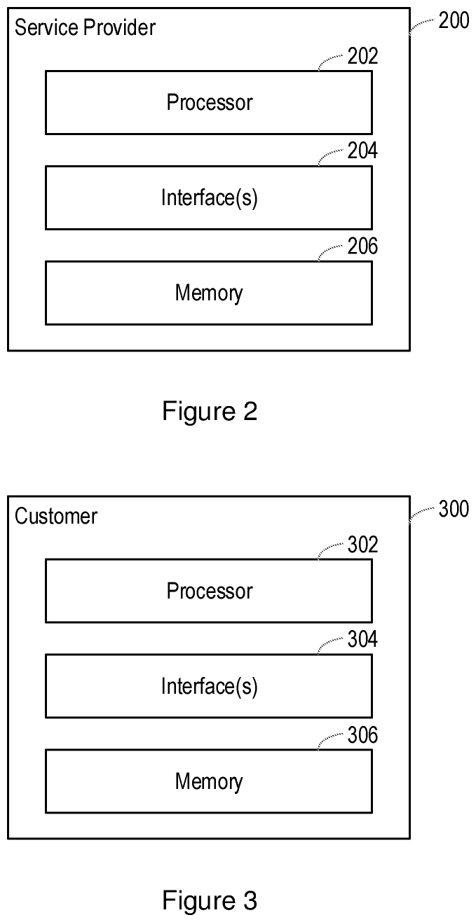

FIG. 2 illustrates a first network node 200 according to some embodiments comprising processing circuitry (or logic) 202. The processing circuitry 202 controls the operation of the first network node 200 and can implement the method described herein in relation to a first network node 200. The processing circuitry 202 can comprise one or more processors, processing units, multi-core processors or modules that are configured or programmed to control the first network node 200 in the manner described herein. In particular implementations, the processing circuitry 202 can comprise a plurality of software and/or hardware modules that are each configured to perform, or are for performing, individual or multiple steps of the method described herein in relation to the first network node 200.

Briefly, the processing circuitry 202 of the first network node 200 is configured to perform a method for executing a machine-learning model, the method comprising: developing a first machine-learning model, based on a first set of data and using a machine-learning algorithm; communicating to a second network node the first machine-learning model; receiving from the second node information about a difference between the first machine-learning model and a second machine-learning model; receiving a request for the execution of a machine-learning model; responsive to receiving the request for the execution of the machine-learning model, obtaining information indicative of an execution policy; and, depending on the obtained information indicative of an execution policy, either: executing a machine-learning model based on the first machine-learning model and the information about a difference between the first machine-learning model and the second machine-learning model, to obtain a result; or partially executing the first machine-learning model, and causing the second node to partially execute the second machine-learning model, to obtain a result.

In some embodiments, the step of partially executing the first machine-learning model, and causing the second node to partially execute the second machine-learning model at the second node to obtain a result comprises: partially executing the first machine-learning model; and causing the second node to partially execute the second machine-learning model based on the information about a difference between the first machine-learning model and the second machine-learning model.

In some embodiments, the first network node 200 may optionally comprise a communications interface 204. The communications interface 204 of the first network node 200 can be for use in communicating with other nodes, such as other virtual nodes. For example, the communications interface 204 of the first network node 200 can be configured to transmit to and/or receive from other nodes requests, resources, information, data, signals, or similar. The processing circuitry 202 of the first network node 200 may be configured to control the communications interface 204 of the first network node 200 to transmit to and/or receive from other nodes requests, resources, information, data, signals, or similar.

Optionally, the first network node 200 may comprise a memory 206. In some embodiments, the memory 206 of the first network node 200 can be configured to store program code that can be executed by the processing circuitry 202 of the first network node 200 to perform the method described herein in relation to the first network node 200. Alternatively or in addition, the memory 206 of the first network node 200 can be configured to store any requests, resources, information, data, signals, or similar that are described herein. The processing circuitry 202 of the first network node 200 may be configured to control the memory 206 of the first network node 200 to store any requests, resources, information, data, signals, or similar that are described herein.

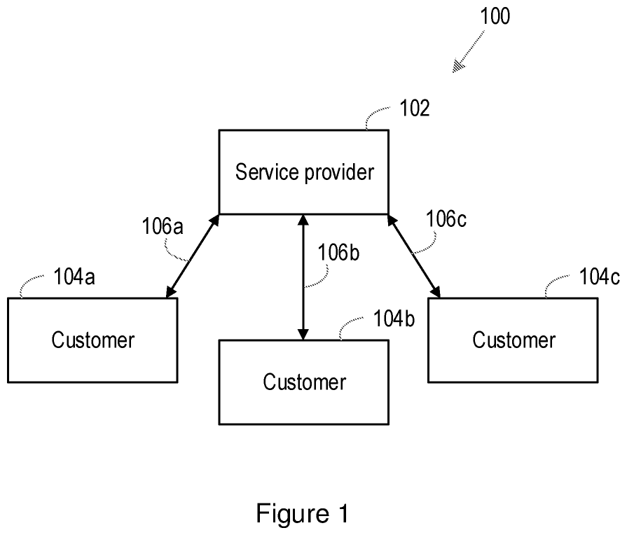

The first network node 200 described herein may comprise the central node 102, for example in a service provider, or any other suitable network node comprised within a suitable network (such as the network 100 in FIG. 1).

FIG. 3 illustrates a second network node 300 according to some embodiments comprising processing circuitry (or logic) 302. The processing circuitry 302 controls the operation of the second network node 300 and can implement the method described herein in relation to a second network node 300. The processing circuitry 302 can comprise one or more processors, processing units, multi-core processors or modules that are configured or programmed to control the second network node 300 in the manner described herein. In particular implementations, the processing circuitry 302 can comprise a plurality of software and/or hardware modules that are each configured to perform, or are for performing, individual or multiple steps of the method described herein in relation to the second network node 300.

Briefly, the processing circuitry 302 of the second network node 300 is configured to perform a method for executing a machine-learning model, the method comprising: receiving, from a first node, a first machine-learning model; developing a second machine-learning model, based on the first machine-learning model and a second set of data, and using a machine-learning algorithm; communicating, to the first node, information about a difference between the first machine-learning model and the second machine-learning model; receiving, from the first node, a partial result; partially executing the second machine-learning model, using the first partial result, to form a second partial result; and communicating, to the first node, the second partial result.

In some embodiments, the second network node 300 may optionally comprise a communications interface 304. The communications interface 304 of the second network node 300 can be for use in communicating with other nodes, such as other virtual nodes. For example, the communications interface 304 of the second network node 300 can be configured to transmit to and/or receive from other nodes requests, resources, information, data, signals, or similar. The processing circuitry 302 of the second network node 300 may be configured to control the communications interface 304 of the second network node 300 to transmit to and/or receive from other nodes requests, resources, information, data, signals, or similar.

Optionally, the second network node 300 may comprise a memory 306. In some embodiments, the memory 306 of the second network node 300 can be configured to store program code that can be executed by the processing circuitry 302 of the second network node 300 to perform the method described herein in relation to the second network node 300. Alternatively or in addition, the memory 306 of the second network node 300, can be configured to store any requests, resources, information, data, signals, or similar that are described herein. The processing circuitry 302 of the second network node 300 may be configured to control the memory 306 of the second network node 300 to store any requests, resources, information, data, signals, or similar that are described herein.

The second network node 300 described herein may comprise an edge node 104a, 104b, 104c, for example in a customer, or any other suitable network node comprised within a suitable network (such as the network 100 in FIG. 1).

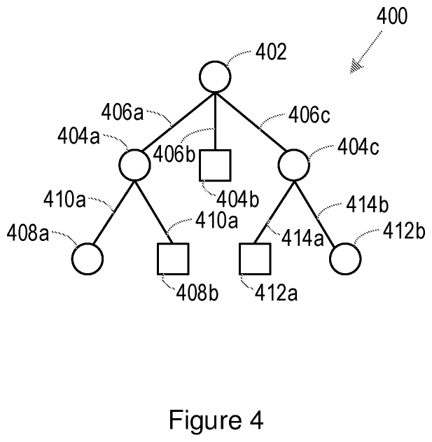

FIG. 4 shows an example of a decision tree 400. It will be appreciated that the decision tree 400 is an example of a computational graph.

The first node comprised within the decision tree 400 is the root node 402. The root node 402 is the topmost node of the decision tree 400, and therefore does not have a parent node. All the other nodes comprised within the decision tree 400 can be reached from the root node 402 by following the edges (links) of the decision tree 400.

In this example, the root node 402 has three child nodes, 404a, 404b and 404c. These child nodes 404a, 404b and 404c of the root node 402 can be reached from the root node 402 by the edges 406a, 406b and 406c, respectively.

In this example, the child node 404a of the root node 402 has two child nodes itself, 408a and 408b (which can be reached from the node 404a by the edges 410a and 410b, respectively). The child node 404c of the root node 402 also has two child nodes itself, 412a and 412b (which can be reached from the node 404c by the edges 414a and 414b, respectively). Thus, the nodes 402, 404a and 404c of the decision tree 400 can be described as internal nodes (or alternatively, branch nodes) of the decision tree 400. An internal node of the decision tree 400 is any node comprised within the decision tree 400 that has child nodes.

In this example, the child node 404b of the root node 402 has no child nodes. Similarly, the nodes 408a, 408b, 412a and 412b have no child nodes. Thus, the nodes 404b, 408a, 408b, 412a and 412b may be described as external nodes (or alternatively, leaf nodes) of the decision tree 400. An external node of the decision tree 400 is any node comprised within the decision tree 400 that has no child nodes.

The decision tree 400 may be used as a machine-learning model. The machine-learning model will begin at the root node 402, and for any given node of the decision tree 400, the machine leaning-model will only pass to one of the child nodes of that node.

In one example, the decision tree 400 may be used to predict a presently unknown class of a categorical variable, based on one or more other continuous, or categorical, variables, for which the value of these variables are known. In another example, the decision tree 400 may be used to predict a presently unknown value of a continuous variable, based on one or more other continuous, or categorical variables, for which the value of these variables are known. Thus, it will be appreciated that an external node of the decision tree 400 may, in some examples, represent a class of a categorical variable. In other examples, an external node of the decision tree 400 may represent a value of a continuous variable. The internal nodes of the decision tree 400 may represent conditions. Whether one or more of the other continuous, or categorical variables, meet said conditions, will determine which child node of the internal node the machine-learning model will pass to. In other words, this will determine how the machine-learning model will progress from the root node 402, to a child node, given the one or more other continuous, or categorical variables, for which the value of these variables are known.

For example, the internal node 404a may represent a threshold value for a continuous variable. If this threshold value is exceeded by the continuous variable, the machine-learning model may pass to the external node 408a, and the output of the machine-learning model will be the class or the value that is represented by the external node 408a. If the continuous variable fails to exceed the threshold value, the machine-learning model may pass to the external node 408b, and the output of the machine-learning model will be the class or the value that is represented by the external node 408b.

It will be appreciated that a decision tree (for example, the decision tree 400) may be generated using ID3, C4.5, CART, or any other suitable machine-learning algorithm. The generation may be based on a training data set. The classifications (in the case of a classification tree) or the regression values (in the case of a regression tree) that the machine-learning model will be aiming to accurately predict will already be known prior to the application of the training data set to the decision tree 400.

Furthermore, it will be appreciated that the decision tree 400 is an example of a directed acyclic graph (DAG). A directed acyclic graph is a directed graph that contains no directed cycles.

A random forest (or alternatively, a random decision forest) is a machine learning model which generates a plurality of decision trees from a set of training data. In other words, a random forest is an ensemble of decision trees. It will be appreciated that each of these plurality of decision trees again may be generated using ID3, C4.5, CART, or any other suitable machine-learning algorithm. However, the set of training data may be randomly sampled with replacement, and each randomly sampled sub-set of the training data may then be used to train a corresponding decision tree comprised within the random forest. However, any other suitable method of generating a random forest may be used.

As a machine-learning model, the random forest will either output the class that is the mode of the classes that are output by the individual decision trees of the random forest, or the random forest will output the value that is the mean of the values that are output by the individual decision trees of the random forest. Thus, the output value or class predicted by the random forest may be more accurate than the output value or class predicted by an individual decision tree.

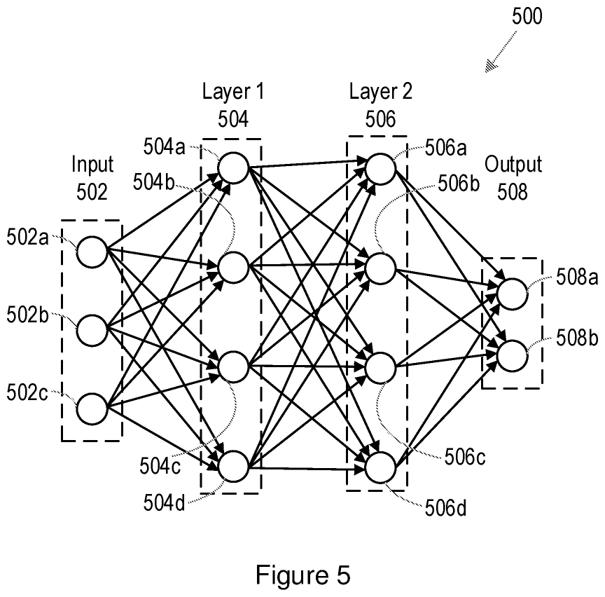

FIG. 5 shows an example of a neural network 500. It will be appreciated that the neural network 500 is an example of a computational graph.

The neural network 500 comprises four layers; an input layer 502, a first hidden layer 504, a second hidden layer 506 and an output layer 508. Thus, in this example, the neural network 500 comprises two hidden layers. However, it will be appreciated that the neural network 500 may comprise any number of hidden layers.

A neural network 500 may be used as a machine-learning model. The machine-learning model will begin at the input layer 502, and at each layer, will pass to the layer directly following that layer, until the output layer 508 is reached.

In one example, the neural network 500 may be used to predict a presently unknown class of a categorical variable, based on one or more other continuous, or categorical, variables, for which the value of these variables are known. In another example, the neural network 500 may be used to predict a presently unknown value of a continuous variable, based on one or more other continuous, or categorical variables, for which the value of these variables are known.

In this example, the input layer 502 comprises three nodes, 502a, 502b and 502c. However, it will be appreciated that the input layer of the neural network 500 may comprise any suitable number of input nodes. The number of input nodes may correspond to the number of known variables that are to be input into the neural network 500.

In this example, the output layer comprises two output nodes 508a and 508b. However, it will be appreciated that the output layer of the neural network 500 may comprise any suitable number of output nodes. For example, the number of output nodes may represent the number of possible classes that a variable may be predicted to be. Additionally, the value output by each of the output nodes may represent the probability that the variable belongs to each of the classes that each of the output nodes respectively represent.

As mentioned above, the neural network 500 comprises two hidden layers. The first hidden layer 504 comprises four nodes, 504a, 504b, 504c and 504d. The second hidden layer 506 also comprises four nodes, 506a, 506b, 506c and 506d. However, it will be appreciated that a hidden layer within the neural network 500 may comprise any suitable number of nodes.

As seen in the illustrated example of FIG. 5, the nodes 502a, 502b, 502c comprised within the input layer 502 are each connected to each of the nodes 504a, 504b, 504c, 504d comprised within the first hidden layer 504. Thus, the information that is input into the input layer 502 is passed to each node of the first hidden layer 504 along these edges. The edges between the nodes of the neural network 500 may comprise weights. The weights may modify the values that are passing between the nodes.

In some examples, the weights may correspond to the relative “strength” of an input for a particular node, and in some examples may correspond to the dependency of one input to another input at a particular point in the neural network 500.

Each of the nodes 504a, 504b, 504c, 504d within the first hidden layer 504 comprise a mathematical function. The mathematical functions comprised within each of the nodes 504a, 504b, 504c, 504d may be the same functions, or they may be different functions. The mathematical function comprised within a node will be applied upon the data that has been input into said node. For example, the mathematical function that is comprised within the node 504a will be applied to the data that has been passed to node 504a from the nodes 502a, 502b and 502c.

Following this application of the mathematical function, the result of applying the mathematical function comprised within the node will passed to the next layer of the neural network 500. For example, the result of applying the mathematical function comprised within the node 504a will be passed to the nodes 506a, 506b, 506c and 506d comprised within the second hidden layer 506, along the edges that connect node 504a and each of the nodes 506a, 506b, 506c and 506d respectively.

Each of the nodes 506a, 506b, 506c, 506d within the second hidden layer 506 comprise a mathematical function. The mathematical functions comprised within each of the nodes 506a, 506b, 506c, 506d may be the same functions, or they may be different functions. The mathematical function that is comprised within a node will be applied upon the data that has been input into said node. For example, the mathematical function that is comprised within the node 506a will be applied to the data that has been passed to node 506a from the nodes 504a, 504b, 504c and 504d.

Following this application of the mathematical function, the result of applying the mathematical function comprised within the node will passed to the next layer of the neural network 500. For example, the result of applying the mathematical function comprised within the node 506a will be passed to the nodes 508a and 508b comprised within the output layer 508, along the edges that connect node 506a and each of the nodes 508a and 508b respectively.

Thus, it will be appreciated that the nodes comprised within the hidden layers of the neural network 500 will comprise mathematical functions which may be applied to the data that has been passed to the nodes, and the result of applying these mathematical functions may then be passed to the nodes comprised within the next layer of the neural network 500.

Each of the nodes 508a, 508b within the output layer 508 comprise a mathematical function. The mathematical functions comprised within each of the nodes 508a, 508b may be the same functions, or they may be different functions. The mathematical function that is comprised within a node will be applied upon that data that has been input into said node. For example, the mathematical function that is comprised within the node 508a will be applied to the data that has been passed to node 508a from the nodes 506a, 506b, 506c and 506d.

The mathematical functions comprised within the nodes 508a, 508b of the output layer 508 may, in some examples, be the softmax function. For example, assigning the softmax function to each of the nodes comprised within an output layer of the neural network 500, can provide an indication of the probability that the variable belongs the class that each of the output nodes have respectively been assigned to represent.

The mathematical functions comprised within the nodes of the neural network 500 may also be referred to as activation functions, or alternatively, they may be referred to as transfer functions. A mathematical function may be a non-linear function, in order to introduce non-linearity into the neural network 500, or may be a linear function. For example, the mathematical function may be one of the following functions: a sigmoid function, the hyperbolic tangent function, or the rectified linear function.

Thus, it will be appreciated that the number of hidden layers comprised within the neural network 500, and the number of nodes comprised within a hidden layer, may be a design choice.

The neural network 500 will typically be trained with a training data set. The classifications (in the case of a classification neural network) or the regression values (in the case of a regression neural network) that the machine-learning model will be aiming to accurately predict, will already be known prior to the application of the training data set to the neural network 500. During the training process, the classification output by the neural network 500 (for a classification neural network), or the regression value output by the neural network 500 (for a regression neural network) will be compared to the known classification or the known regression value for the training data that was input into the neural network 500. To improve the accuracies of the predictions of the neural network 500, the weights of the information that are passed along the edges to be input into a node will be adjusted. The weights will be adjusted such that the error corresponding to the output produced by the neural network 500 is minimised. The skilled person will be familiar with methods for training the weights of the neural network 500 such that the error corresponding to the output produced by the neural network 500 is minimised.

Thus, the weights of the neural network 500 will be updated during the training process such that the machine-learning model is trained to produce more accurate outputs. It will be appreciated that, initially, the weights may be set arbitrarily or randomly.

It will be appreciated that the neural network 500 is an example of a directed acyclic graph (DAG). A directed acyclic graph is a directed graph that contains no directed cycles.

Thus, both decision trees and neural networks are examples of machine-learning models that may predict a presently unknown class of a categorical variable, based on one or more other continuous, or categorical, variables, for which the value of these variables are known, or alternatively may be used to predict a presently unknown value of a continuous variable, based on one or more other continuous, or categorical variables, for which the value of these variables are known.

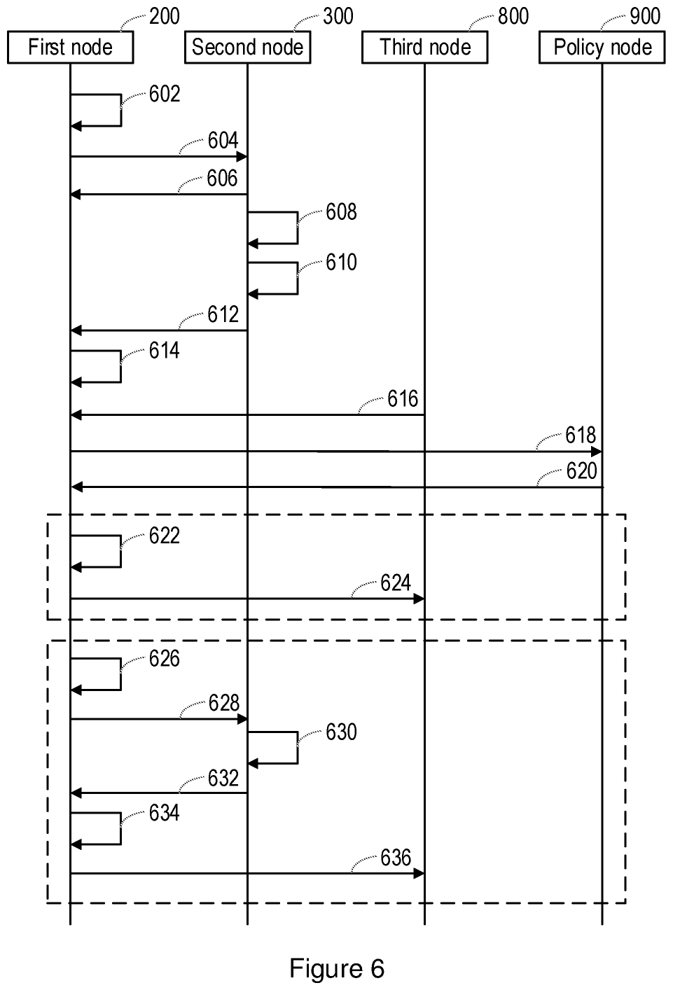

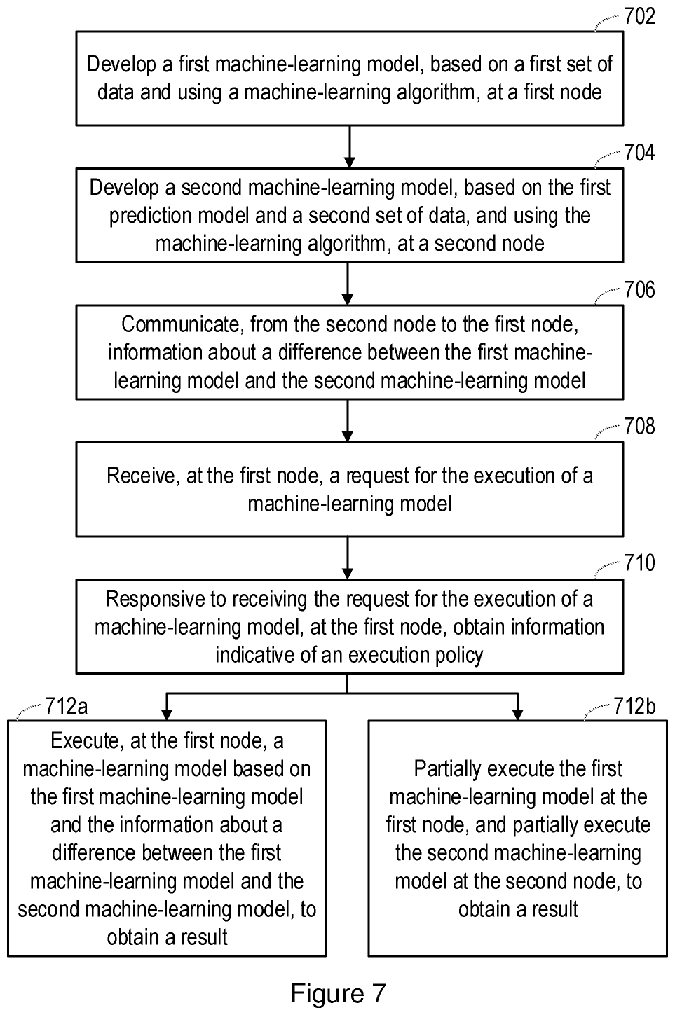

FIG. 6 illustrates a sequence diagram for executing a machine-learning model, and FIG. 7 illustrates a method for executing a machine-learning model. The methods described herein may be executed in the network 100.

At step 602, a first machine-learning model is developed at the first network node 200, based on a first set of data and using a machine-learning algorithm.

In some embodiments, the first set of data may have been generated at the first network node 200. Alternatively, in some embodiments, the first set of data may have been received from one or more external source. Alternatively, in some embodiments, the first set of data may comprise data that has been generated at the first network node 200, and data that has been received from one or more external source. The source of the first set of data may be dependent on security and/or privacy requirements of the network 100. For example, it may be a requirement of the network 100 that data is not communicated such that it passes from a network node that it was generated in, to a network node that it was not generated in.

In some embodiments, the first set of data is split such that 80% of the first set of data is used to initially train the first machine-learning model, and the remaining 20% of the first set of data is used to verify the outputs of the trained first machine-learning model.

However, it will be appreciated that any suitable split, for the purposes of training and verification of a machine-learning model, may be used for the first set of data.

It will be appreciated that the first machine-learning model may be one of the machine-learning algorithms as described above. For example, the first machine-learning model may be a decision tree (for example, the decision tree 400), a neural network (for example, the neural network 500), or a random forest. However, it will be appreciated that the first machine-learning model may be any machine-learning model that employs a computational graph. For example, the first machine-learning model may be a support vector machine. In some embodiments, the computational graph that is employed may be a directed acyclic graph.

It will be appreciated that the machine-learning algorithm that is used to develop the first machine-learning model may be any suitable machine-learning algorithm for the first machine-learning model. By means of illustrative example, in which the first machine-learning model is a decision tree (for example, the decision tree 400), the decision tree may be generated using ID3, C4.5, CART, or any other suitable machine-learning algorithm.

Thus, as shown at step 702 of the method of FIG. 7, a first machine-learning model, based on a first set of data and using a machine-learning algorithm, is developed at a first node.

At step 604, the first machine-learning model is communicated to the second network node 300. In some embodiments, a serialised version of the first machine-learning model may be communicated to the second network node 300. A serialised version may be a way in which information may be represented that is more optimised towards network transfer, than for example a way of representing information that makes the information accessible to a program (for example, a data structure that is stored in memory which a program may reads to access data). For example, in some embodiments where the first machine-learning model comprises a neural network, the serialised version of the first machine-learning model may comprise the structure of the neural network, and the weights of the neural network. Additionally or alternatively, this communication between the first network node 200 and the second network node 300 may be encrypted.

At step 606, the second network node 300 communicates an acknowledgement to the first network node 200, that the first machine-learning model has been received by the second network node 300.

At step 608, a second machine-learning model, based on the first machine-learning model and a second set of data, is developed at the second network node 300 using the machine learning algorithm.

In some embodiments, the second set of data may have been generated at the second network node 300. Alternatively, in some embodiments, the second set of data may have been received from one or more external source. Alternatively, in some embodiments, the second set of data may comprise data that has been generated at the second network node 300, and data that has been received from one or more external source. The source of the second set of data may be dependent on security and/or privacy requirements of the network 100. For example, it may be a requirement of the network 100 that data is not communicated such that it passes from a network node that it was generated in, to a network node that it was not generated in. In other words, the data (or the information) that is generated at the second node 300, may never be communicated to the first node 200, in some examples.

In some embodiments, the first set of data is split such that 80% of the second set of data is used to initially train the second machine-learning model, and the remaining 20% of the second set of data is used to verify the outputs of the trained second machine-learning model. However, it will be appreciated that any suitable split, for the purposes of training and verification of a machine-learning model, may be used for the second set of data.

The machine-learning algorithm that is used to develop the second machine-learning model may be one of the machine-learning algorithms as described above. Specifically, the machine-learning algorithm that is used to develop the second machine-learning model may be the same as the machine-learning algorithm that is used to develop the first machine-learning model.

It will be appreciated that the second machine-learning model may be one of the machine-learning models as described above. For example, the second machine-learning model may be a decision tree (for example, the decision tree 400), a neural network (for example, the neural network 500), or a random forest. However, it will be appreciated that the second machine-learning model may be any machine-learning model that employs a computational graph. For example, the second machine-learning model may be a support vector machine. In some embodiments, the computational graph may be a directed acyclic graph.

It will be appreciated that the machine-learning algorithm that is used to develop the second machine-learning model may be any suitable machine-learning algorithm for the second machine-learning model. By means of illustrative example, in which the second machine-learning model is a decision tree (for example, the decision tree 400), the decision tree may be generated using ID3, C4.5, CART, or any other suitable machine-learning algorithm.

As described above, the second machine-learning model is based on the first machine-learning model. Thus, in some embodiments, the second-machine learning model may be substantially similar to the first machine-learning model, but where the second machine-learning model comprises one or more mutations when compared to the first machine-learning model.

For example, where the first machine-learning model and the second machine-learning model are decision trees having the form of the decision tree 400 shown in FIG. 4, the internal node 404a of the first machine-learning model may represent a first condition; whereas the internal node 404a of the second machine-learning model may represent a second condition, where the first condition is different from the second condition. For example, the first condition may comprise a first threshold for a particular variable, and the second condition may comprise a second threshold for the particular variable. This mutation may result as the further training of the second machine-learning model is based on the second set of data.

In another example, where the first machine-learning model and the second machine-learning model are random forests, the first machine-learning model may comprise a number of individual decision trees, and the second machine-learning model may comprise the same number of individual decision trees. However, one or more of the individual decision trees of the second machine-learning model may differ from the individual decision trees of the first machine-learning model. For example, as a result of training the second machine-learning model based on the second set of data, one or more individual decision trees generated as a result of this training may be different to the individual decision trees that were generated as a result of training the first-machine learning model based on the first set of data. Additionally or alternatively, one or more individual decision trees of the second machine-learning model may change (for example, by mutation, addition or deletion) in a manner as described in greater detail below. These mutations may result as the further training of the second machine-learning model is based on the second set of data.

In another example, where the first machine-learning model and the second machine-learning model are neural networks having the general form of the neural network 500 shown in FIG. 5, one or more of the weights of the edges that connect the nodes of the second machine-learning model may be different to the weights of the edges that connect the nodes of the first machine-learning model. This mutation may result as the training of the second machine-learning model is based on the second set of data, as opposed to the first set of data.

Additionally or alternatively, in some embodiments, the second-machine learning model may be substantially similar to the first machine-learning model, but where the second-machine learning model comprises one or more additions when compared to the first machine-learning model.

For example, where the first machine-learning model and the second machine-learning model are decision trees having the form of the decision tree 400 shown in FIG. 4, the internal node 404a of the first machine-learning model may have two child nodes, 408a, 408b as shown in FIG. 4; whereas the internal node 404a of the second machine-learning model may have the child nodes 408a and 408b, and may also have an additional child node. This addition may result as the further training of the second machine-learning model is based on the second set of data.

In another example, where the first machine-learning model and the second machine-learning model are random forests, the first machine-learning model may comprise a first number of individual decision trees, and the second machine-learning model may comprise a second number of individual decision trees, where the first number is greater than the second number. This deletion may result as the training of the second machine-learning model is based on the second set of data, as opposed to the first set of data.

In another example, where the first machine-learning model and the second machine-learning model are neural networks having the general form of the neural network 500 shown in FIG. 5, the first machine-learning model may comprise two hidden layers 502 and 504; whereas the second machine-learning model may comprise the hidden layers 502, 504, and an additional hidden layer. This addition may result as the further training of the second machine-learning model is based on the second set of data.

Additionally or alternatively, in some embodiments, the second-machine learning model may be substantially similar to the first machine-learning model, but where the second-machine learning model comprises one or more deletions when compared to the first machine-learning model.

For example, where the first machine-learning model and the second machine-learning model are decision trees having the form of the decision tree 400 shown in FIG. 4, the internal node 404a of the first machine-learning model may have two child nodes, 408a, 408b; whereas the internal node 404a of the second machine-learning model may only have the child node 408a. This deletion may result as the further training of the second machine-learning model is based on the second set of data.

In another example, where the first machine-learning model and the second machine-learning model are random forests, the first machine-learning model may comprise a first number of individual decision trees, and the second machine-learning model may comprise a second number of individual decision trees, where the first number is less than the second number. This addition may result as the further training of the second machine-learning model is based on the second set of data.

In another example, where the first machine-learning model and the second machine-learning model are neural networks having the general form of the neural network 500 shown in FIG. 5, the first machine-learning model may comprise two hidden layers 502 and 504; whereas the second machine-learning model may only comprise one hidden layer 502. This deletion may result as the further training of the second machine-learning model is based on the second set of data.

Thus, it will be appreciated that the second machine-learning model may comprise one or more mutations, and/or one or more additions, and/or one of more deletions, when compared to the first machine-learning model.

Thus, as shown at step 704 of the method of FIG. 7, a second machine-learning model, based on the first machine-learning model and a second set of data, and using the machine-learning algorithm, is developed at a second node

At step 610, a difference between the first machine-learning model, and the second machine-learning model, is determined at the second network node 300.

In some embodiments, this difference may be identified through a comparison of the first machine-learning model and the second machine-learning model. In some embodiments, the difference may be identified as additions (or insertions) to the second-machine learning model, when compared with the first-machine learning model. Additionally or alternatively, the difference may be identified as deletions from the second-machine learning model, when compared with the first-machine learning model. Additionally or alternatively, the difference may be identified as mutations of the second-machine learning model, when compared with the first-machine learning model.

At step 612, information about the difference between the first machine-learning model and the second machine-learning model is communicated from the second network node 300, to the first network node 200. In some embodiments, a serialised version of the information about the difference may be communicated to the first network node 200. For example, in some embodiments where the first machine-learning model and the second machine-learning model each comprise a decision tree, the serialised version of the information about the difference may comprise an indication where in the structure of the first machine-learning model the difference or differences between the first machine-learning model and the second machine-learning model exist. Additionally or alternatively, this communication between the second network node 300 and the first network node 200 may be encrypted.

In some embodiments, the information about the difference may comprise information that the second machine-learning model is different from the first machine-learning model. For example, the information about the difference may comprise a checkpoint when there is a difference between the first-machine learning model and the second-machine learning model, and not comprise a checkpoint when there is a not difference between first-machine learning model and the second-machine learning model. In another example, the information about the difference may comprise a message when there is a difference between the first-machine learning model and the second-machine learning model, and not comprise a message when there is a not difference between first-machine learning model and the second-machine learning model. In other words, in some embodiments, if no difference exists between the second machine-learning model and the first machine-learning model, no information is transmitted from the second network node 300 to the first network node 200.

In some embodiments, the information about the difference may comprise information that the second machine-learning model is different from the first machine-learning model, or may comprise information that the second machine-learning model is not different to the first machine-learning model. For example, the information about the difference may comprise a checkpoint that is set when there is a difference between the first-machine learning model and the second-machine learning model, and comprise a checkpoint that is not set when there is not a difference between first-machine learning model and the second-machine learning model. In another example, the information about the difference may comprise a first message when there is a difference between the first-machine learning model and the second-machine learning model, and comprise a second message when there is not a difference between first-machine learning model and the second-machine learning model. In other words, in some embodiments, information is transmitted from the second network node 300 to the first network node 200, regardless of whether a difference exists between the first machine-learning model and the second machine-learning model.

In some embodiments, the information about the difference between the first machine-learning model and the second machine-learning model further comprises information identifying a difference between the first machine-learning model and the second machine-learning model. For example, the information about the difference may further comprise an identifying message that identifies the difference between the first machine-learning model and the second machine-learning model. In some embodiments, the information identifying the difference may identify the type of difference. For example, the information may identify that the difference comprises one of more addition, and/or one or more deletion, and/or one or more mutation (as described above). In some embodiments, the information may identify the location within the second-machine learning model where the difference exists.

Thus, in some embodiments, although information relating to a difference between the first machine-learning model and the second machine-learning model is communicated between the first and second network nodes, the second machine-learning model itself is not communicated between the first and second network nodes. This may be a security and/or privacy requirement of the network 100, as it may be possible, at the first network node 200 (should it receive the second machine-learning model from the second network node 300), to infer information relating to the second set of data (which the second machine-learning model is based upon), despite the second set of data having not been communicated to the first network node 200.

In some embodiments, the information about the difference between the first machine-learning model and the second machine-learning model may further comprise the second-machine learning model.

Thus, as shown at step 706 of the method of FIG. 7, information about a difference between the first machine-learning model and the second machine-learning model is communicated from the second node to the first node.

At step 614, the information about the difference between the first machine-learning model and the second machine-learning model is attached to the first machine-learning model at the first network node 200. In some embodiments, a checkpoint or a message may be attached to the first machine-learning model, indicating that a difference between the first machine-learning model and the second machine-learning model exists. In some embodiments, an identifying checkpoint or an identifying message may be attached to the first machine-learning model, identifying where the difference exists, and/or identifying what the difference is. For example, the identifying checkpoint or the identifying message may indicate that the difference is one or more additions, and/or one or more deletions, and/or one or more mutations.

In some embodiments, the step of attaching information about the difference between the first machine-learning model and the second machine-learning model may comprise updating the first machine-learning model such that the difference between the first machine-learning model and the second machine-learning model is incorporated into the first machine-learning model.

At step 616, a request for execution of a machine-learning model is received at the first network node 200. The request is communicated by a third node 800. The third node 800 may be any suitable network node comprised within a suitable network (such as network 100). The request for execution will typically be accompanied by a set of inference data. The set of inference data will comprise data corresponding to one or more variables, and the execution of the machine-learning model will provide either a classification, or a regression value for a different variable that the machine-learning model has been trained to predict, based upon the values and/or classes of the one or more input variables.

It will be appreciated that the third node 800, when requesting the execution of a machine-learning model at the first network node 200, may be unaware of the current state of the first machine-learning model. In other words, the third node 800 may be unaware that the second machine-learning has been developed at the second network node 300, and/or of any difference between the first machine-learning model and the second-machine learning model.

Thus, as shown at step 708 of the method of FIG. 7, a request for execution of a machine-learning model is received at the first node.

At step 618, the first network node 200 communicates a request for information indicative of an execution policy to a policy node 900. The policy node 900 may be any suitable network node comprised within a suitable network (such as network 100). In some embodiments, the communicated request may comprise information relating to the first network node 200 and to the second network node 300. In some embodiments, this information may then be used by the policy node 900, to determine information indicative of an execution policy that is to be communicated to the first network node 200.

At step 620, the policy node 900 communicates information indicative of an execution policy to the first network node 200. Thus, responsive to receiving the request for the execution of the machine-learning model, the first network node 200 obtains information indicative of an execution policy.

In this illustrated embodiment, the information indicative of an execution policy is obtained from the policy node 900. However, it will be appreciated that, in some embodiments, the information indicative of an execution policy may be obtained from memory in the first network node 200.

It will be appreciated that the policy node 900 may be accessible both to the first network node 200 and to the second network node 300.

In some embodiments, the information indicative of an execution policy may indicate that, at the first network node 200, a machine-learning model based on the first machine-learning model and the information about a difference between the first machine-learning model and the second machine-learning model should be executed, to obtain a result. Optionally, the information indicative of the execution policy may further comprise information indicating that at least part of said machine-learning model should be executed in an enclaved mode.

Generally, when a machine-learning model is executed in an enclaved mode, the machine-learning model will be executed in an enclaved memory segment. An enclaved memory segment will be described in greater detail below.

Alternatively, in some embodiments, the information indicative of an execution policy may indicate that the first machine-learning model should be partially executed at the first network node 200, and that the second machine-learning model should be partially executed at the second node, to obtain a result. Optionally, the information indicative of the execution policy may further comprise information indicating that at least one component of said first machine-learning model or of said second machine-learning model should be executed in an enclaved mode.

Thus, as shown at step 710 of the method of FIG. 7, responsive to receiving the request for the execution of the machine-learning model, information indicative of an execution policy is obtained at the first node.

Depending on the information indicative of the execution policy that is obtained by the first network node 200, the first network node 200 may respond to the request for execution of the machine-learning model in one of two ways.

In a first embodiment (as shown at steps 622 and 624 of FIG. 6), the first network node 200 may execute a machine-learning model based on the first machine-learning model and the information about a difference between the first machine-learning model and the second machine-learning model, to obtain a result.

In some embodiments, the step of executing a machine-learning model based on the first machine-learning model and the information about a difference between the first machine-learning model and the second machine-learning model, to obtain a result, may comprise updating the first machine-learning model such that the difference between the first machine-learning model and the second machine-learning model is incorporated into the first machine-learning model, to form the machine-learning model. This machine learning-model (which has been formed at the first network node 200), may then be executed, to obtain a result.

In some embodiments, the step of executing may comprise at least partially executing, at the first network node 200, the machine-learning model based on the first machine-learning model and the information about a difference between the first machine-learning model and the second machine-learning model in an enclaved memory segment.

An enclaved memory segment provides a secure and encrypted memory space. Furthermore, an enclaved memory segment can only be accessed by the processing circuity of the network node the enclaved memory segment is comprised within, and not by any other means. Thus, the machine-learning model may be executed, and a result (or in some embodiments, a partial result) may be obtained, without revealing the intermediate steps of executing the model itself. A possible advantage of this may be that security is improved when the machine-learning model is executed. For example, as only the processing circuitry 202 of the first network node 200 may access the machine-learning model, the privacy of the data set that has been used to update the machine learning model is more ensured (for example, the third node 800 will not have access to the updated model, and thus will not be able to infer any information relating to the data that has been used to train that model).

An enclaved memory segment relies on the network node in which the model is being executed comprising specific hardware. For example, the first network node 200 may comprise Intel SGX™ or AMD™ hardware, where the memory encryption of the hardware is relied upon to provide the enclaved memory segment.

At step 624, the first network node 200 communicates the obtained result to the third node 800.

Thus, as shown at step 712a of the method of FIG. 7, at the first node, a machine-learning model based on the first machine-learning model and the information about a difference between the first machine-learning model and the second machine-learning model is executed to obtain a result.

Thus, as a result of executing a machine-learning model, where the machine learning model is formed at the first network node 200 as a result of updating the first machine-learning model such that the difference between the first machine-learning model and the second machine-learning model is incorporated into the first machine-learning model, at the first network node 200 in an enclaved memory segment, a machine learning-model is provided which advantageously comprises the updates that have been provided by training the second machine-learning model at the second network node 300, but does not reveal or infer information relating to the data that was used to train the model at the second network node 300, to the third node 800. Thus, the result that is obtained by executing the machine-learning model will likely be more accurate (as the machine-learning model comprises the aforementioned updates), and furthermore, the privacy of the data that has been used to provide this update has not been compromised.

Additionally, the need to communicate large volumes of data from the second network node 300, to the first network node 200 is reduced. Furthermore, the amount of data storage required at the first network node 200 is reduced.

In a second embodiment (as shown at steps 626 to 636 of FIG. 6), the first machine-learning model may be partially executed at the first network node 200, and the second machine-learning model may be partially executed at the second network node 300, to obtain a result.

At step 626, the first network node 200 partially executes the first machine-learning model. The first machine-learning model will be partially executed using the inference data set. In some embodiments, the partial execution that occurs at the first network node 200 is based on the information about the difference between the first machine-learning model and the second machine-learning model.

For example, the information about the difference between the first machine-learning model and the second machine-learning model may comprise information regarding the position of the first machine-learning model where the difference between the first machine-learning model and the second machine-learning model exists. The first machine-learning model may then be executed up to the point at which this difference exists.

In another example, where the first and second machine-learning models are decision trees (for example, decision trees of the same general as the decision tree 400 shown in FIG. 4), the information about the difference may indicate the node in the first machine-learning model at which the first machine-learning model and the second machine-learning model begin to differ from one another. In another example, where the first and second machine-learning models are neural networks (for example, neural networks of the same general form as the neural network 500 shown in FIG. 5), the information about the difference may indicate the layer in the first machine-learning model at which the first machine-learning model and the second machine-learning model begin to differ from one another. The first machine-learning model may be executed up to the point at which this difference exists.

In another example, where the first and second machine-learning models are random forests, the information about the difference may indicate one or more individual decision trees, and additionally or alternatively, a node in one or more individual decision trees, of the first machine-learning model where the first machine-learning model and the second machine-learning model begin to differ from one another. The first machine-learning model may be executed up to the point at which this difference exists.

In other words, the information about the difference between the first machine-learning model and the second machine-learning model may dictate the point at which the first machine-learning model should be executed up to. That is, the information about the difference between the first machine-learning model and the second machine-learning model may dictate at which point the execution of the first machine-learning model should be branched out such that the second machine-learning model begins to be executed. Thus, the update that is comprised within the second machine-learning model at the second network node 300 is included in the execution of the machine-learning model.

In some embodiments, as a result of partially executing the first machine-learning model at the first network node 200, a first partial result is formed. For example, where the first and second machine-learning models comprise decision trees (for example, decision trees of the same general form as the decision tree 400 shown in FIG. 4), the first partial result may be the set of inference data, and optionally, an indication of the node at which the execution of the decision tree of the second machine-learning model should be resumed. In another example, where the first and second machine-learning models comprise neural networks (for example, neural networks of the same general form as the neural network 500 shown in FIG. 5), the first partial result may comprise the set of information that has been output from the layer that directly precedes the layer where the difference exists between the first and second machine-learning models. For example, where the first and second machine-learning models comprise random forests, the first partial result may be the set of inference data, and optionally, an indication of one or more decision trees that are comprised within the random forest where execution is to be resumed, optionally, for each of these one or more decision trees, an indication of the node at which the execution of the one or more decision trees of the second machine-learning model should be resumed.

In other words, a first partial result may be a vector which is used as an input by the second machine-learning model, where the input is orchestrated by the information about a difference that exists between the first and second-machine learning models.

In some embodiments, the step of partially executing the first machine-learning model at the first network node 200 may comprise executing at least one component of the first machine-learning model at the first network node 200 in an enclaved memory segment.

Execution of the at least one component of the first machine-learning model at the first network node 200 in an enclaved memory segment may be performed in substantially the same manner, and may achieve at least some of the aforementioned advantages, as discussed above.

At step 628, the first partial result is communicated to the second network node 300. Thus, in some embodiments, the first network node 200 causes the second machine-learning model to be partially executed at the second network node 300, based on the information about a difference between the first machine-learning model and the second machine-learning model. In some embodiments, the communication of the first partial result may be encrypted.

At step 630, the second network node 300 partially executes the second machine-learning model, using the first partial result, to form a second partial result. In some embodiments, the partial execution that occurs at the second network node 300 is based on the information about the difference between the first machine-learning model and the second machine-learning model.

For example, the information about the difference between the first machine-learning model and the second machine-learning model may comprise information regarding the position of the first machine-learning model where the difference between the first machine-learning model and the second machine-learning model exists. The second machine-learning model may be executed over the part of the second machine-learning model where this difference exists.

In another example, where the first and second machine-learning models are decision trees (for example, decision trees of the same general form as the decision tree 400 shown in FIG. 4), the information about the difference may indicate the node in the first machine-learning model at which the first machine-learning model and the second machine-learning model begin to differ from one another. In another example, where the first and second machine-learning models are neural networks (for example, neural networks of the same general form as the neural network 500 shown in FIG. 5), the information about the difference may indicate the layer in the first machine-learning model at which the first machine-learning model and the second machine-learning model begin to differ from one another. The second machine-learning model may be executed over the part of the second machine-learning model where this difference exists.

In another example, where the first and second machine-learning models are random forests, the information about the difference may indicate one or more individual decision trees, and additionally or alternatively, a node in one or more individual decision trees, of the first machine-learning model where the first machine-learning model and the second machine-learning model begin to differ from one another. The second machine-learning model may be executed over the part of the second machine-learning model where this difference exists.

In other words, the information about the difference between the first machine-learning model and the second machine-learning model may dictate the part of the second machine-learning model which should be executed. Thus, the partial execution of the second machine-learning model may only be an execution of the parts of the second machine-learning model that have been indicated as different from the first machine learning model.

In some embodiments, as a result of partially executing the second machine-learning model at the second network node 300, a second partial result is formed. For example, where the first and second machine-learning models comprise decision trees (for example, decision trees of the same general form as the decision tree 400 shown in FIG. 4), the second partial result may be the set of inference data, and optionally, an indication of the node at which the execution of the first machine-learning model should be resumed. In another example, where the first and second machine-learning models comprise neural networks (for example, neural networks of the same general form as the neural network 500 shown in FIG. 5), the second partial result may comprise the set of information that has been output from the final layer that has been determined to be different between the first machine-learning model and the second machine-learning model, and optionally, an indication of the layer that directly succeeds this layer. For example, where the first and second machine-learning models comprise random forests, the second partial result may be the set of inference data, optionally, an indication of one or more decision trees that are comprised within the random forest where execution is to be resumed, and optionally, for each of these one or more decision trees, an indication of the node at which the execution of the one or more decision trees of the second machine-learning model should be resumed.

In some embodiments, the step of partially executing the second machine-learning model at the second network node 300 to obtain a result may comprise executing at least one component of the second machine-learning model at the second network node 300 in an enclaved memory segment.

Execution of the at least one component of the second machine-learning model at the second network node 300 in an enclaved memory segment may be performed in substantially the same manner, and may achieve at least some of the aforementioned advantages, as discussed above.

At step 632, the second network node 300 communicates the second partial result to the first network node 200. In some embodiments, the communication of the second partial result may be encrypted.

At step 634, the first network node 200 partially executes the first machine-learning model, using the second partial result, to form a final result. In other words, the result of executing the second machine-learning model is communicated to the first network node 200, and the execution of the first machine-learning model is resumed at the appropriate place, combining the result of executing the second machine-learning model appropriately.

In some cases, depending on the difference between the second machine-learning model and the first machine-learning model, the result of executing the second machine-learning model at the second node may be the final result. In that case, there is no need for the first network node to partially execute the first machine-learning model, using the result received from the second network node, in order to form the final result.

In some embodiments, where the first and second machine-learning models comprise decision trees (for example, decision trees of the same general form as the decision tree 400 shown in FIG. 4), the first machine-learning model may be executed in its entirety at the first network node 200, to form the first partial result, and the second machine-learning model may be executed in its entirety at the second network node 300, to form the second partial result. The final result may then be formed at the first network node 200, for example, by averaging the first partial result and the second partial result. In another example, the final result may then be formed at the first network node 200, by combining the first partial result and the second partial result. In another example, the final result may then be formed at the first network node 200, by forming a weighted average of the first partial result and the second partial result.

In some embodiments, where the first and second machine-learning models comprise random forests, the first machine-learning model may be executed in its entirety at the first network node 200, to form the first partial result, and the second machine-learning model may be executed in its entirety at the second network node 300, to form the second partial result. The final result may then be formed at the first network node 200, for example, by averaging the first partial result and the second partial result. In another example, the final result may then be formed at the first network node 200, by combining the first partial result and the second partial result. In another example, the final result may then be formed at the first network node 200, by forming a weighted average of the first partial result and the second partial result.

At step 636, the first network node 200 communicates the obtained result to the third node 800.

Thus, as shown at step 712b of the method of FIG. 7, the first machine-learning model is partially executed at the first node, and the second machine-learning model is partially executed at the second node, to obtain a result.

Thus, in some examples, the information about a difference that exists between the first and second-machine learning models may therefore provide a way of tracking how a machine-learning model should be executed across different network nodes in the network 100. In another example, versioning of the first and second machine-learning models may provide a way of tracking the execution of a machine-learning model in the network 100. For example, by referring to previous generations of the second machine-learning model, information about a difference between the first machine-learning model and the second machine-learning model may be determined, and may therefore provide a way of tracking how a machine-learning model should be executed across different network nodes in the network 100.

Thus, as a result of partially executing the first machine-learning model at the first network node 200, and partially executing the second machine-learning model at the second network node 300, a machine learning-model is provided which advantageously comprises the updates that have been provided by training the second machine-learning model at the second network node 300, but does not reveal or infer information relating to the data that was used to train the model at the second network node 300, to the third node 800, or to the first network node 200. Thus, the result that is obtained by executing the machine-learning model will likely be more accurate (as the machine-learning model comprises the aforementioned updates) and furthermore, the privacy of the data that has been used to provide this update has not been compromised.

Additionally, the need to communicate large volumes of data from the second network node 300, to the first network node 200 is reduced. Furthermore, the amount of data storage required at the first network node 200 is reduced.

In other words, in this described second embodiment, the computational graph of a machine-learning model may be appropriately separated into one or more components, where these components may be executed in one or more nodes, while maintaining the directed acyclic graph of the machine-learning model. For example, where the machine-learning model comprises a decision tree (for example, the decision tree 400), the nodes of the decision tree may be executed separately in one or more network nodes. In another example, where the machine-learning model comprises a neural network (for example, the neural network 500), the layers of the neural network may be executed separately in one or more network nodes. As described above, the one or more components of the machine-learning model may be trained independently in the one or more nodes. The execution policy described herein may indicate where the one or more components of the machine-learning model are to be executed. Additionally, the execution policy described herein may indicate whether the one or more components of the machine-learning model are to be executed in an enclaved memory segment (if the enclaved memory segment is supported by the hardware of the network nodes in which the execution is taking place), or not. In some embodiments, the execution of the machine-learning model may be controlled by the policy node 900.

It will be appreciated that the methods described herein may be applicable to any machine-learning model that comprises a directed acyclic graph.

There is therefore provided a method and apparatus for executing a machine-learning model that is based upon the policies that exist between the different nodes where different parts of the machine-learning model have been updated.

It should be noted that the above-mentioned embodiments illustrate rather than limit the concepts disclosed herein, and that those skilled in the art will be able to design many alternative embodiments without departing from the scope of the appended following statements. The word “comprising” does not exclude the presence of elements or steps other than those listed in a statement, “a” or “an” does not exclude a plurality, and a single processor or other unit may fulfil the functions of several units recited in the statements. Any reference signs in the statements shall not be construed so as to limit their scope.

1-34. (canceled)

35. A computer-implemented method for executing a machine-learning model performed in a first network node, the method comprising:
developing a first machine-learning model, based on a first set of data and using a machine-learning algorithm;
communicating to a second network node, the first machine-learning model;
receiving from the second network node, information about a difference between the first machine-learning model and a second machine-learning model;
receiving a request for the execution of a machine-learning model;
responsive to receiving the request for the execution of the machine-learning model, obtaining information indicative of an execution policy; and
depending on the obtained information indicative of the execution policy, either:
executing a machine-learning model based on the first machine-learning model and the information about a difference between the first machine-learning model and the second machine-learning model, to obtain a result; or
partially executing the first machine-learning model and causing the second network node to partially execute the second machine-learning model, to obtain a result.

36. The method according to claim 35, wherein partially executing the first machine-learning model, and causing the second network node to partially execute the second machine-learning model at the second network node to obtain a result comprises:
partially executing the first machine-learning model; and
causing the second network node to partially execute the second machine-learning model based on the information about a difference between the first machine-learning model and the second machine-learning model.

37. The method according to claim 35, wherein the information about a difference between the first machine-learning model and the second machine-learning model comprises any one or more of:
information that the second machine-learning model is different from the first machine-learning model;
information that the second machine-learning model is different from the first machine-learning model, or information that the second machine-learning model is not different from the first machine-learning model;
information identifying a difference between the first machine-learning model and the second machine-learning model; or
the second machine-learning model.

38. The method according to claim 35, wherein the information indicative of an execution policy is obtained from a policy node or is obtained from memory in the first network node.

39. The method according to claim 35, wherein, when the information indicative of the execution policy comprises information indicating execution of the machine-learning model based on the first machine-learning model and the information about a difference between the first machine-learning model and the second machine-learning model, said information further comprises information indicating that at least part of said machine-learning model should be executed in an enclaved mode.

40. The method according to claim 35, wherein, when the information indicative of the execution policy comprises information indicating partial execution of the first machine-learning model, and partial execution of the second machine-learning model, said information further comprising information indicating that at least one component of said first machine-learning model or of said second machine-learning model should be executed in an enclaved mode.

41. The method according to claim 35, wherein the first machine-learning model and the second machine-learning model are representable as computational graphs.

42. The method according to claim 41, wherein the computational graphs are directed acyclic graphs.

43. The method according to claim 41, wherein the first machine-learning model and the second machine-learning model are each one of the following: neural networks, support vector machines, decision trees, and random forests.

44. The method according to claim 35, wherein the step of executing a machine-learning model based on the first machine-learning model and the information about a difference between the first machine-learning model and the second machine-learning model to obtain a result comprises at least partially executing a machine-learning model based on the first machine-learning model and the information about a difference between the first machine-learning model and the second machine-learning model in an enclaved memory segment.

45. The method according to claim 35, wherein the step of partially executing the first machine-learning model, and causing the second network node to partially execute the second machine-learning model, to obtain a result comprises one or more of:
executing at least one component of the first machine-learning model in an enclaved memory segment;
causing the second network node to partially execute the second machine-learning model in an enclaved memory segment;
partially executing the first machine-learning model, to form a first partial result;
communicating to the second network node, the first partial result;
causing the partial execution of the second machine-learning model, using the first partial result, at the second network node, such that a second partial result is formed at the second network node;
receiving, from the second network node, the second partial result; or
partially executing the first machine-learning model, using the second partial result, to form a final result.

46. A first network node for executing a machine-learning model, the first network node comprising:
an interface configured for allowing communication with other network nodes; and
processing circuitry operatively associated with the interface and configured to:
develop a first machine-learning model, based on a first set of data and using a machine-learning algorithm;
communicate the first machine-learning model to a second network node;
receive, from the second network node, information about a difference between the first machine-learning model and a second machine-learning model;
receive a request for the execution of a machine-learning model;
responsive to receiving the request for the execution of the machine-learning model, obtain information indicative of an execution policy; and
depending on the obtained information indicative of an execution policy, either:
execute a machine-learning model based on the first machine-learning model and the information about a difference between the first machine-learning model and the second machine-learning model, to obtain a result; or
partially execute the first machine-learning model and cause the second network node to partially execute the second machine-learning model, to obtain a result.

47. A method for executing a machine-learning model performed in a second network node, the method comprising:
receiving, from a first network node, a first machine-learning model;
developing a second machine-learning model, based on the first machine-learning model and a second set of data, and using the machine-learning algorithm;
communicating, to the first network node, information about a difference between the first machine-learning model and the second machine-learning model;
receiving, from the first network node, a partial result;
partially executing the second machine-learning model, using the first partial result, to form a second partial result; and
communicating, to the first network node, the second partial result.

48. The method according to claim 47, wherein the information about a difference between the first machine-learning model and the second machine-learning model comprises:
information that the second machine-learning model is different from the first machine-learning model; and/or
information that the second machine-learning model is different from the first machine-learning model, or information that the second machine-learning model is not different from the first machine-learning model; and/or
information identifying a difference between the first machine-learning model and the second machine-learning model; and/or
the second machine-learning model.

49. The method according to claim 47, wherein the machine-learning model and the second machine-learning model are representable as computational graphs.

50. The method according to claim 49, wherein the computational graphs are directed acyclic graphs.

51. The method according to claim 49, wherein the first machine-learning model and the second machine-learning model are each one of the following: neural networks, support vector machines, decision trees, and random forests.

52. The method according to claim 47, wherein the step of partially executing the second machine-learning model, using the first partial result, to form a second partial result, comprises executing at least one component of the second machine-learning model at the second node in an enclaved memory segment.

53. A network node for executing a machine-learning model, the network node referred to as a second network node and comprising:
an interface configured for allowing communication with other network nodes;
processing circuitry operatively associated with the interface and configured to:
receive, from a first network node, a first machine-learning model;
develop a second machine-learning model, based on the first machine-learning model and a second set of data, and using the machine-learning algorithm;
communicate, to the first network node, information about a difference between the first machine-learning model and the second machine-learning model;
receive, from the first network node, a partial result;
partially execute the second machine-learning model, using the first partial result, to form a second partial result; and
communicate, to the first network node, the second partial result.
